(19) United States
(12) Patent Application Publication
(10) Pub. No.: US 2015/0317368 A1
(43) Pub. Date: Nov. 5, 2015

(54) COMPUTERIZED SYSTEMS AND METHODS FOR DOCUMENTING AND PROCESSING LAW ENFORCEMENT ACTIONS

(71) Applicant: THIN BLUE LINE REPORTING, LLC, Oro Valley, AZ (US)

(72) Inventors: Jonathan Rhoads, Oro Valley, AZ (US); Jacob Rhoads, Tucson, AZ (US)

(21) Appl. No.: 14/697,361

(22) Filed: Apr. 27, 2015

Related U.S. Application Data
(60) Provisional application No. 61/984,298, filed on Apr. 25, 2014.

(51) Int. Cl. G06F 17/30; G06F 17/24

(52) U.S. Cl. CPC G06F 17/30554; G06F 17/248; G06F 17/30424; G06Q 50/18

(57) ABSTRACT

A computerized system for documenting and processing law enforcement actions is provided. The system includes at least one law enforcement officer computer device operating a law enforcement action documenting and processing application. The application provides an interface for generating reports, and the interface includes a plurality of preconfigured report templates. A report is generated by providing relevant information into fields within a selected report template. The system further includes a law enforcement station computer system, at least one third party data systems storing information relevant to law enforcement activities, and a law enforcement cloud service for storing reports. The law enforcement cloud service is configured to facilitate a search of the at least one third party data systems based on information received from the at least one law enforcement officer computer device, provide to the at least one law enforcement officer computer device, as a result of the search, information corresponding with the information received from the at least one law enforcement officer computer device, store the received reports, and provide the law enforcement station computer systems with access to the stored reports. The law enforcement action documenting and processing application populates a field in the selected report template with the information resulting from the search.

### CROSS REFERENCE TO RELATED APPLICATIONS

This application claims priority from U.S. Provisional Application 61/984,298, filed Apr. 25, 2014, the contents of which are incorporated herein in their entirety.

### FIELD OF DISCLOSURE

The present disclosure is generally related to report generating and processing, and more particularly is related to computerized systems and methods for documenting and processing law enforcement actions utilizing mobile computer devices for generating reports.

### BACKGROUND OF THE DISCLOSURE

It is conventional for a law enforcement officer to have a computer, typically a laptop, mounted within the officer's vehicle. Such computers often include a platform that allows the officer to retrieve available records based on an input identifying a person, vehicle, or the like. However, these platforms are typically limited, single-purpose programs for accomplishing a specific type of task, i.e. searching a particular database for matching records. Further, these platforms generally have access only one or a few databases, such as the particular law enforcement agency's records database. Another drawback to such computers for law enforcement is that they are cumbersome and typically mounted in a vehicle, and thus are generally only useful when the officer is inside the vehicle. Such computer systems are of very little value to an officer on foot, bicycle, motorcycle or otherwise anywhere outside of a patrol car.

Thus, a heretofore unaddressed need exists in the industry to address the aforementioned deficiencies and inadequacies.

### SUMMARY OF THE DISCLOSURE

Embodiments of the present disclosure provide computerized systems and methods for documenting and processing law enforcement actions. Briefly described, in architecture, one embodiment of the system, among others, can be implemented as follows. The system includes at least one law enforcement officer computer device operating a law enforcement action documenting and processing application. The application provides an interface for generating reports, and the interface includes a plurality of preconfigured report templates. A report is generated by providing relevant information into fields within a selected report template. The system further includes a law enforcement station computer system, at least one third party data systems storing information relevant to law enforcement activities, and a law enforcement cloud service for storing reports. The law enforcement cloud service is configured to facilitate a search of the at least one third party data systems based on information received from the at least one law enforcement officer computer device, provide to the at least one law enforcement officer computer device, as a result of the search, information corresponding with the information received from the at least one law enforcement officer computer device, store the received reports, and provide the law enforcement station computer systems with access to the stored reports. The law enforcement action documenting and processing application populates a field in the selected report template with the information resulting from the search.

In another embodiment, the present disclosure provides a computerized method for documenting and processing law enforcement actions that includes the steps of: providing a law enforcement action documenting and processing application for at least one law enforcement officer computer device operating, the law enforcement action documenting and processing application providing an interface for generating reports, the interface for generating reports including a plurality of preconfigured report templates, whereby a report is generated by providing relevant information into fields within a selected report template; providing a law enforcement cloud service for storing reports, hosted at least partially on a server and electronically accessible over at least one network system to the at least one law enforcement officer computer device and a law enforcement station computer system, the law enforcement cloud service being configured to: facilitate a search of at least one third party data systems based on information received from the at least one law enforcement officer computer device, wherein the at least one third party data systems store information relevant to law enforcement activities, and include at least one of a law enforcement Records Management System and a judicial system database; provide to the at least one law enforcement officer computer device, as a result of the search, information corresponding with the information received from the at least one law enforcement officer computer device, the law enforcement action documenting and processing application being operable to populate a field in the selected report template with the information resulting from the search; store reports received from the at least one law enforcement officer computer device; and provide the law enforcement station computer systems with access to the stored reports.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a block diagram illustrating a computerized system for documenting and processing law enforcement actions, in accordance with a first exemplary embodiment of the present disclosure.

FIGS. 2-5 are illustrations of various views or screens of a graphical user interface, in accordance with embodiments provided by the present disclosure.

FIG. 6 is an illustration of a graphical user interface for configuring settings within a law enforcement action documenting and processing application, in accordance with embodiments provided by the present disclosure.

### DETAILED DESCRIPTION

In the following description, reference is made to the accompanying drawings, which form a part hereof, and in which is shown, by way of illustration, various embodiments of the present disclosure. It is understood that other embodiments may be utilized and changes may be made without departing from the scope of the present disclosure.

Many embodiments of the disclosure may take the form of computer-executable instructions, including algorithms executed by a programmable computer. However, the disclosure can be practiced with other computer system configurations as well. Certain aspects of the disclosure can be embodied in a special-purpose computer or data processor that is specifically programmed, configured or constructed to perform one or more of the computer-executable algorithms described below. Accordingly, the term “computer” as generally used herein refers to any data processor and includes Internet appliances, hand-held devices (including palm-top computers, wearable computers, cellular or mobile phones, multi-processor systems, processor-based or programmable consumer electronics, network computers, minicomputers) and the like.

The disclosure also can be practiced in distributed computing environments, where tasks or modules are performed by remote processing devices that are linked through a communications network. Moreover, the disclosure can be practiced in Internet-based or cloud computing environments, where shared resources, software and information may be provided to computers and other devices on demand. In a distributed computing environment, program modules or subroutines may be located in both local and remote memory storage devices. Aspects of the disclosure described below may be stored or distributed on computer-readable media, including magnetic and optically readable and removable computer disks, fixed magnetic disks, floppy disk drive, optical disk drive, magneto-optical disk drive, magnetic tape, hard-disk drive (HDD), solid state drive (SSD), compact flash or non-volatile memory, as well as distributed electronically over networks including the cloud. Data structures and transmissions of data particular to aspects of the disclosure are also encompassed within the scope of the disclosure.

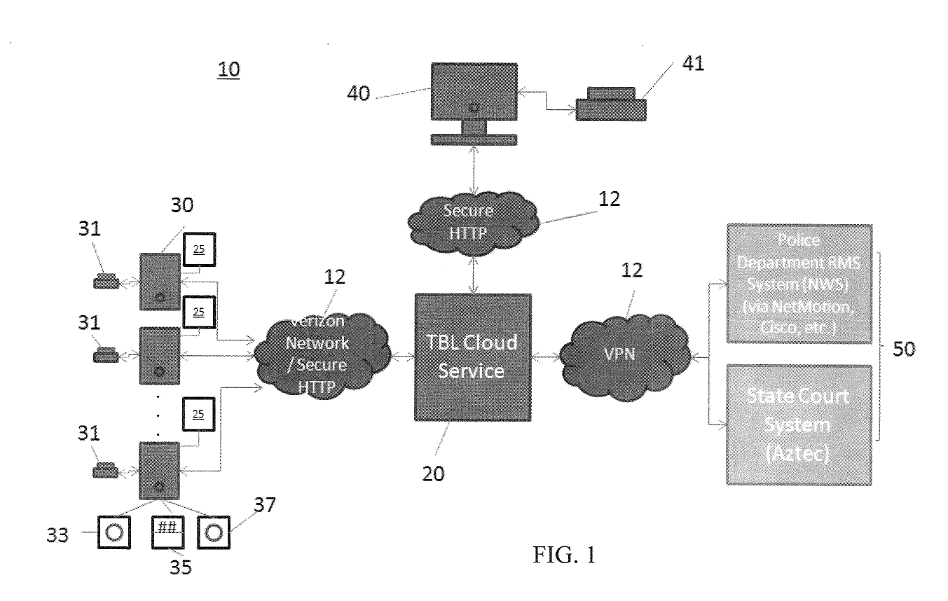

FIG. 1 is a schematic illustration of a computerized system for documenting and processing law enforcement activities 10, in accordance with a first exemplary embodiment of the present disclosure. The computerized system for documenting and processing law enforcement actions 10, which may also be referred to as ‘system 10,’ includes one or more law enforcement officer computer devices 30 containing, or having access to, a law enforcement action documenting and processing application 25 (which may be referred to as ‘application 25’). While the application 25 is described primarily herein as being hosted and run locally on the law enforcement officer computer devices 30, it will be readily understood that the application 25 may be hosted remotely and electronically accessible to the law enforcement officer computer devices 30 over any network system. For example, the application 25 may be included within, or available through, the law enforcement cloud service 20 of system 10, which may be hosted on one or more servers and accessible to law enforcement officer computer devices 30 through a network system 12.

The law enforcement cloud service 20 provides a platform for securely processing, storing and providing access to data through the system 10. Such data may include reports, documents and the like generated by law enforcement officers using computer devices 30, and may further include data provided by third party data systems and databases 50, as well as data provided or accessed by law enforcement station computer systems 40. The cloud service 20 may be hosted at least partially on a server and may include any database capable of storing and/or providing access to information, such as an electronic database, a computer and/or computerized server, database server or generally any network host capable of storing data and connected to any type of data network. Further, the cloud service 20 may include or be a part of a distributed network or cloud computing environment. Any type of electronic and/or computerized device that is capable of storing information may be included in the cloud service 20, and is considered within the scope of this disclosure. The cloud service 20 may include computer-readable storage media, and a processor for processing data and executing algorithms, including any of the processes and algorithms set forth in this disclosure. Further, the cloud service 20 may be under the operational control of a company or entity providing the cloud service 20 to users of the system (e.g., law enforcement officers and departments).

The law enforcement cloud service 20 is electronically accessible over at least one network system 12 to the one or more law enforcement officer computer devices 30, law enforcement station computer systems 40 and/or third party data systems and databases 50. The network systems 12 may include any type of network infrastructure, such as the Internet, or any other wired, wireless and/or partially wired network. For example, law enforcement officer computer devices 30 (running the application 25) may access the law enforcement cloud service 20 via a network system 12, which may include a cellular communications network (e.g., Verizon network) and communications in system 10 may be encrypted utilizing, for example, Secure Hypertext Transfer Protocol (Secure HTTP). Similarly, communications between law enforcement station computer systems 40 and the cloud service 20 may be Secure HTTP communications provided via network system 12, and the network system 12 may include a virtual private network (VPN) for providing communications between third party data systems and databases 50 and the cloud service 20.

The cloud service 20, law enforcement officer computer devices 30, law enforcement station computer systems 40, third party data systems and databases 50, application 25 and network systems 12 may include a variety of hardware and software components to provide successful functioning of the cloud service and servers, computer devices, databases and the application 25, as is well-known within the art. Further, any features, characteristics, designs and/or functions that are known within the art may be included with the system 10 to further enhance its efficiency.

The one or more law enforcement officer computer devices 30 may be any device that is capable accessing the application 25, for example via a network system 12 or via internal hardware such as a processor and computer-readable memory storing the application 25, and communicating information to and from the law enforcement cloud service 20. The one or more law enforcement officer computer devices 30 preferably are mobile computer devices (e.g., may be tablet-based computers, such as an Apple iPad running the iOS operating system) and may be operated by any user of the system 10, and particularly law enforcement officers who use the system 10 for mobile documenting and processing of law enforcement activities. Any number of law enforcement officer computer devices 30 may use the system 10 at any given time.

The law enforcement station computer systems 40 may be any computer or computer system that is capable of accessing the law enforcement cloud service 20, e.g., for accessing, viewing or modifying law enforcement activity data provided to the cloud service 20 from law enforcement officer computer devices 30, as well as for providing information to the cloud service 20. The law enforcement station computer systems 40 may typically be located within a law enforcement station or headquarters facility, and may be operated by personnel at such a site for managing, processing, decision-making and the like, based on law enforcement activity data provided through the law enforcement cloud service 20.

The law enforcement action documenting and processing application 25 may include any tool, device, system, process or combination thereof for providing of a graphical user interface to the law enforcement officer computer devices 30, for receiving information relating to law enforcement activities from the computer devices 30 (e.g., through user input and/or from software modules, hardware, peripherals and the like, including for example, location information provided by GPS, images and video captured through an associated camera, audio from a microphone, fingerprint readers, retinal scanners, barcode scanners, time and date tagging, as well any other such known components and features for receiving information by a computer device). The application 25 includes a number of modules for documenting and/or processing a variety of types of law enforcement activities. For example, the modules may provide via the graphical user interface forms or templates which may be completed based on input information (e.g., law enforcement officer input and/or information received from GPS, camera, microphone or other such input devices or systems) to document and/or process various types of law enforcement activities (e.g., traffic violations, accident reports, investigative or interview reports, and so on).

The application 25 may include any computer-readable memory or databases, which may be stored in any computer-readable medium, and may be accessible by a computer processor. The application 25 may further include or access computer program instructions which may cause a processor to perform any algorithms and/or functions which may be described in this disclosure.

The system 10 further includes third party data systems and databases 50, which may include, for example, law enforcement Records Management Systems (RMS) and judicial system (e.g., State or Federal court systems) databases or systems. The law enforcement Records Management System (RMS) may be, for example, any system used by a law enforcement agency for law enforcement records management, and may be an RMS utilized by a particular law enforcement agency (e.g., a particular police department that a law enforcement officer utilizing computer device 30 belongs to), one or more centralized, multi-agency Records Management Systems, and/or may include records provided through multiple, independently operated Records Management Systems. Similarly, the judicial system databases or systems may be centralized or collaborative systems having judicial system information from multiple courts or court systems, or may include a number of separate, independent databases or systems administered by single courts or court systems.

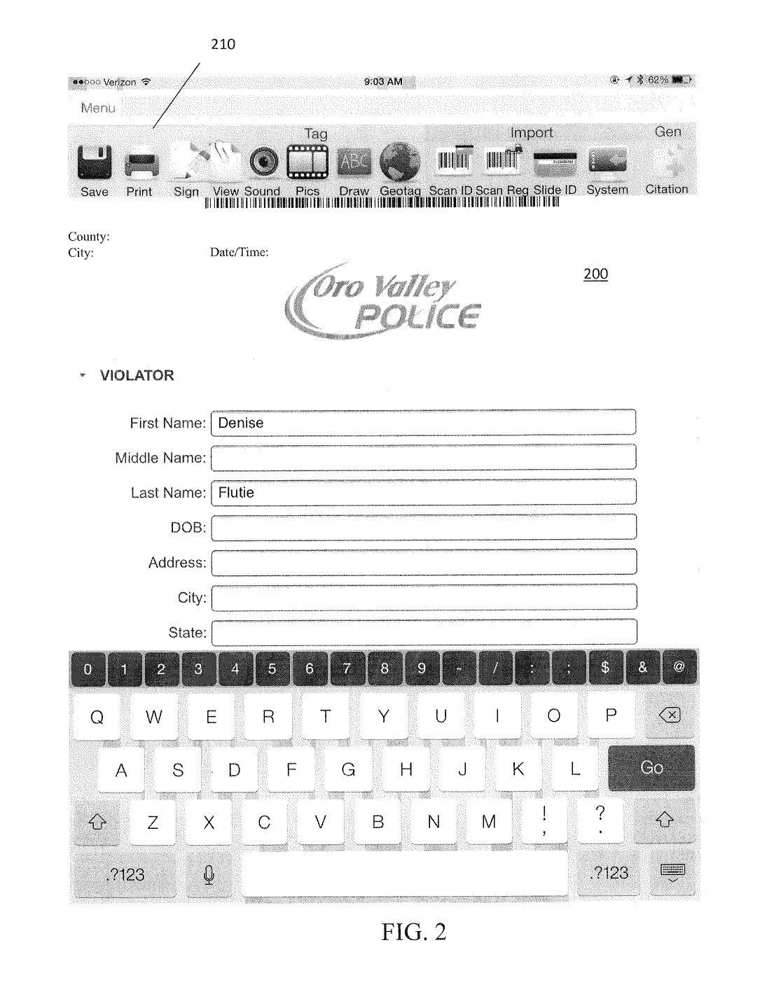

FIGS. 2 through 5 are screenshots illustrating various features and functionality of the system 10, provided as a graphical user interface to a law enforcement officer computer device 30 accessing the application 25, in accordance with embodiments provided by the present disclosure.

As shown in FIG. 2, the law enforcement action documenting and processing application 25 provides a graphical user interface to a law enforcement officer computer device 30, for documenting and processing law enforcement activities. A law enforcement officer may utilize the computer device 30 and application 25 to access a variety of modules, each module having preconfigured form, features and/or functionality for documenting or reporting information associated with specific types of law enforcement activity (e.g., traffic citations, traffic warnings, criminal investigations, witness interviews, crash or accident reports, and so on). As shown in FIG. 2, the module may be a warning module 200, for documenting a violation and/or otherwise providing a warning to a violator of a traffic (or other) law, ordinance, code or the like.

A toolbar 210 is provided in the module 200 and displayed to the user of the law enforcement officer computer device 30, and provides access to various features within the module 200. For example, a report or document (e.g., a warning, citation, etc.) generated through the module 200 may be saved, printed, and signed. Further, “tags” may be appended to or incorporated in the report using tools provided in the toolbar 210. For example, audio recordings may be captured by clicking on the “Sound” icon, which may cause the application 25 to access a microphone integrated in or otherwise accessible to the computer device 30 and allow the user to capture an audio recording relevant to the law enforcement activity (e.g., audio notes provided by the law enforcement officer of the scene of the incident, etc.; audio recording of information provided by witnesses; audio of responses provided by the violator; and so on). Such audio information may be electronically attached or associated with the electronic document or report generated by the module 200. Similarly, using the toolbar 210, a user may electronically “attach” photographs or video to the report, and may access a freehand drawing tool to draw a picture (e.g., position of cars in an intersection where collision occurred, etc.) for attachment to the document.

Certain actions performed in the application 25 may automatically cause the application 25 to capture and “tag” location information, such as may be provided by GPS in the computer device 30. For example, each time the officer opens a new report within a module, the report may be tagged with associated location information as detected by GPS at the time of opening the report. Similarly, photos taken within the application 25, audio recordings and so on may automatically be appended with corresponding GPS information. Further, the user may tag information and/or reports within the application 25 as desired, through a feature provided in the toolbar 210 (e.g., “Geotag”).

Information may be imported into the module 200 through tools which may be accessed through the toolbar 210. For example, a user may access an ID scanner (e.g., a barcode scanner for reading barcode or other code forms on a driver's license) through the module 200, which may utilize any known hardware and/or software for scanning and reading an ID which may be integrated in or otherwise in communication with the computer device 30. Similarly, a vehicle registration scanner/reader, or a scanner/reader for any other type of document containing identifying information, may be accessible through the module 200. Documents having information encoded on a magnetic strip may be read through a tool within the module 200 (e.g. “Slide ID”), and information already stored within or otherwise accessible to the application 25 and/or cloud service 20 may be imported into the report through the toolbar 210 (e.g., “System”).

Information may also be input into the module 200 by the user. For example, a law enforcement officer may enter textual information into fields within a form using a keypad. The application 25 utilizes type-ahead (autofill) technology to suggest a word or phrase that a user may be intending to enter, based on characters entered by the user. Such suggestions may be based on information previously entered into the application 25 or otherwise known to the application 25 (e.g., a name, address, eye color, etc.). The application 25 may further include voice-to-text capability, such that a user may input information by speaking and the application 25 converts the received spoken word (e.g., through a microphone connected to computer device 30) into textual information within the form.

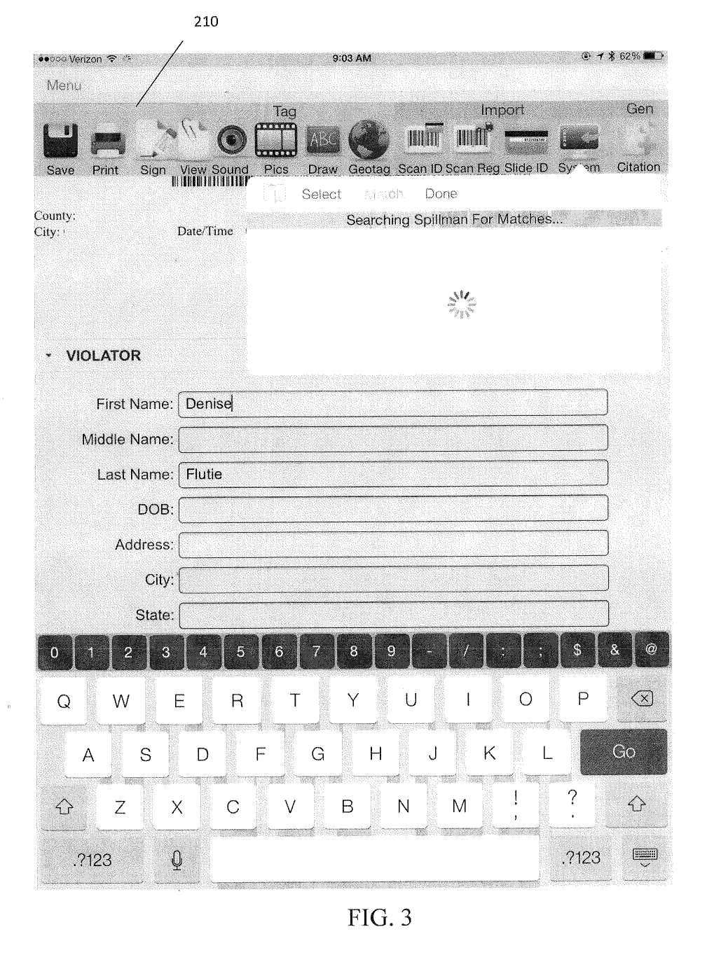

In the example shown in FIG. 2, an officer has entered the first and last name of a violator into the module 200 for generating and reporting a warning. As shown in FIG. 3, the officer may utilize the “System” tool, which searches the system 10 (e.g., by searching information stored in the cloud service 20, law enforcement station computer systems 40 and/or third party data systems and databases 50) for the input name as well as any further information associated with that person.

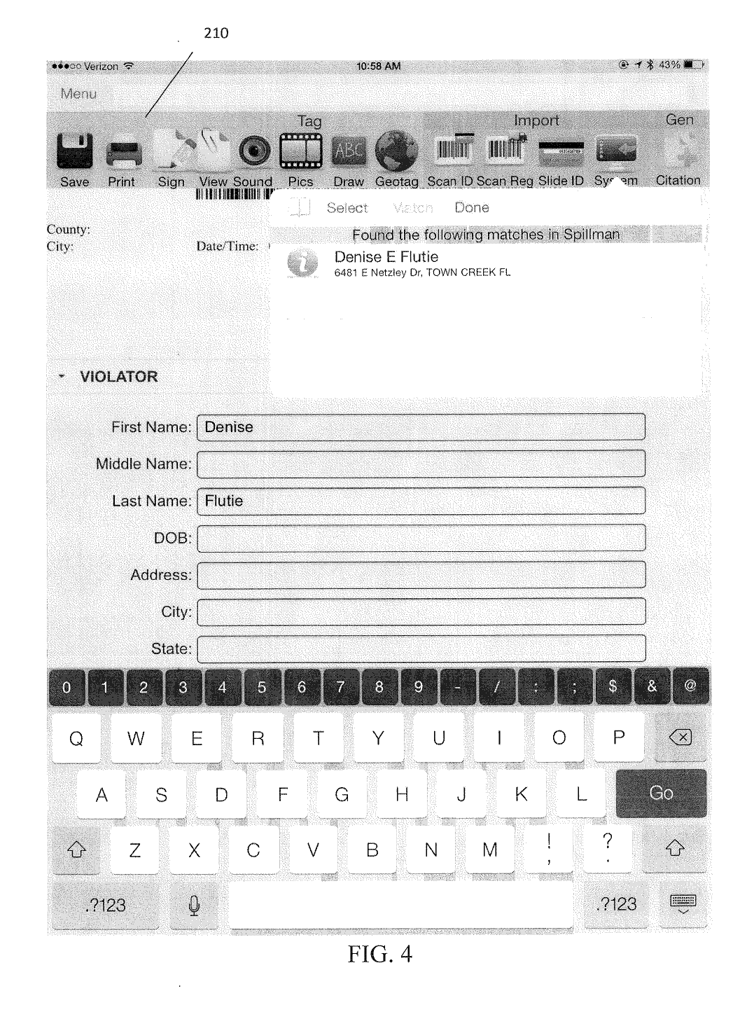

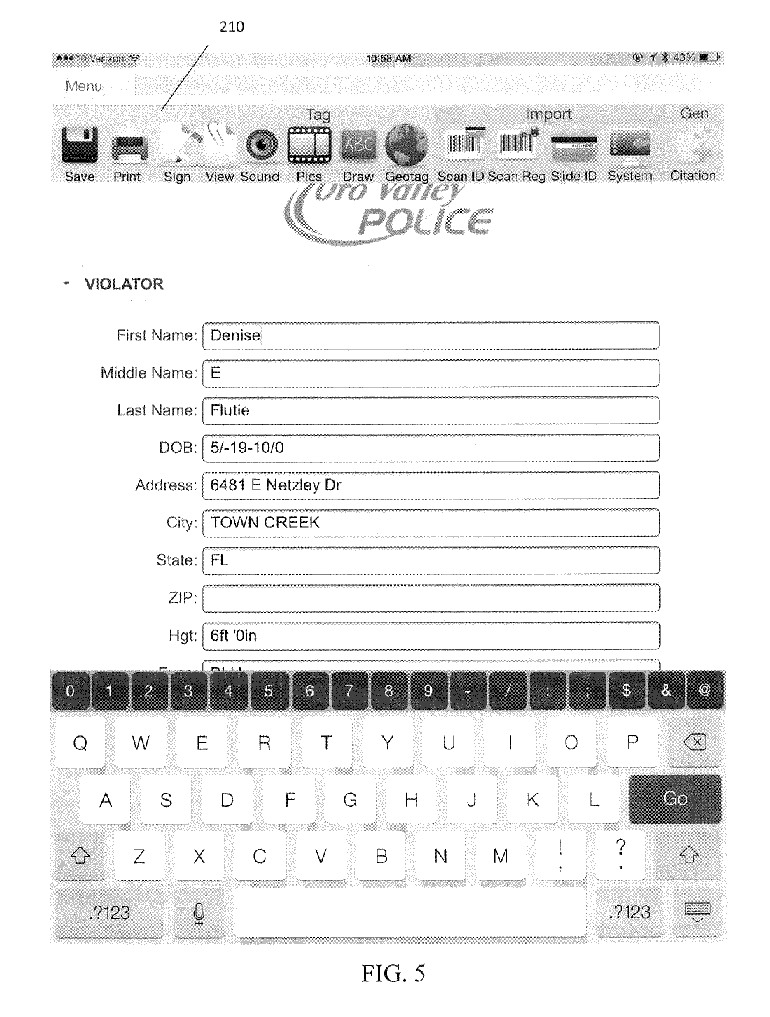

As shown in FIG. 4, the module 200 displays to the user any matching records found resulting from the search for the input name, as well as additional information associated with that named person, such as an address. The officer may then click on or otherwise “accept” the match found via the system search, and the additional information associated with the named person (e.g., as stored in a separate record stored somewhere within the system 10) may be utilized to auto-populate fields in the report provided by the module 200 (e.g., middle name, date of birth, address, city/state, height, and so on), as can be seen in FIG. 5.

While FIG. 2 is shown and described with respect to an officer first inputting a person's name, the name and other associated ID information may be provided in the report through other means, such as by using the computer device 30 to read (e.g., scanning, sliding, etc.) the person's driver's license, registration or other ID card. Such forms of ID are associated with certain identifying information about the person, including name, address, etc. The officer can then cross-check that person against other records within the system 10 by searching the system for matches and additional information may be accessed and utilized to auto-populate fields within the report, as described with respect to FIGS. 3-5.

In addition to providing further information associated with a person for inclusion in the report, searching the system 10 for a person may uncover other information relevant to law enforcement activities, and which may trigger a notice to the officer which may lead to further law enforcement actions. For example, searching RMS or judicial records, as well as any other third party data systems and databases (e.g., FBI databases, etc.) may reveal that warrants have been issued for the person's arrest, that the person is wanted in another state, that the person's driver's license has been revoked, and so on. Such information may be flagged for the officer's attention, and may cause the officer to take further action, such as issuance of a citation, detainment, co-ordination with other law enforcement agencies or the like.

Further, information may be automatically included in a report based on information accessed from third party data systems and databases 50. For example, in generating a citation or other such report within the system 10, a court date and location for the violator may automatically be scheduled and included in the citation form based on information included in a judicial system or court database and referenced by the system 10

After the officer completes a report within a module (e.g., a warning for a driver who has violated a traffic law), the officer may electronically sign the report using the law enforcement officer computer device 30, which locks the report (i.e. from further modification by the law enforcement officer) and automatically uploads the completed report to the law enforcement cloud service 20 for storage, as well as for review and/or final approval by users of the law enforcement station computer systems 40. Report information may be uploaded to the cloud service 20 in response to certain actions taken by a user of the application 25 and law enforcement officer computer device 30 (e.g., by saving, signing or submitting a report, or by pre-configured settings which cause synchronization to automatically occur in response to certain actions being taken within the application 25, such as pulling up a new module, or entering specific information, etc.), and further may be automatically synchronized or uploaded to the cloud service 20 periodically, e.g., every thirty minutes. Such synchronization and uploading of report information allows operators of a law enforcement station computer system (e.g., law enforcement command staff) to have access to real-time or near real-time data provided from the field. Such immediate access to information from law enforcement officers (e.g., location-tagged photos and video, input text data, audio recordings from field interviews, etc.) is particularly useful for command center monitoring and decision-making as significant law enforcement-related events unfold.

The report (which may be or include, for example, a citation or a warning to a traffic law violator), may be printed utilizing the toolbar 210 (e.g., the “Print” feature) and a printer 31 connected to the law enforcement officer computer device 30. As such, the law enforcement officer may complete a report, such as a traffic warning, associate or append the report with any audio, photos, video, drawings and/or location information, and then generate and print the completed report (e.g., traffic warning) for on-site delivery to the violator. The system 10 may provide an error indication based on pre-set conditions if a law enforcement officer attempts to print, submit, lock or otherwise finalize a report that is lacking certain required information or otherwise includes erroneous or inconsistent information (e.g., has not been signed, etc.). In such a case, the application 25 may prevent the law enforcement officer from finalizing and submitting the report until such errors have been resolved and the conditions for finalizing the report have been satisfied. Similarly, after a report has been signed and locked or otherwise submitted to the cloud service 20 by a law enforcement officer, law enforcement quality control or other personnel may access the report for review (e.g., utilizing law enforcement station computer systems 40 to access the report in the cloud service 20). Such personnel may have a different type or form of access-level within the application 25, which may allow them to unlock the report (e.g., to edit or modify the report) and send the report back to the law enforcement officer for re-submission after fixing any identified errors or the like.

A violator (or law enforcement officer or other individual, depending on the nature of the report) can electronically sign a report using, for example, fingertip recognition or other such touchscreen technology within a signature block. Similarly, fingerprint information may be provided and associated with a report.

The modules within application 25 may be linked such that information input into one module (e.g., a traffic warning) may be used to populate relevant fields within a second module (e.g., a traffic citation). For example, a law enforcement officer may generate from a first module a warning for a driver having expired registration tags on a vehicle, and then pull up a second module to generate a citation for the same driver because the driver was speeding. Fields within the speeding citation form may be auto-populated with information about the driver that was input (e.g., by scanning the driver's license, textual input, etc.) the warning form in the warning module. The law enforcement officer may generate a citation (or pull up any other module within the application 25), including auto-populated information, using the toolbar 210 (e.g., “Gen Citation”) included within the first module (e.g., a warning module).

The application 25 may include one or more modules, with each module preconfigured to document and/or process (e.g., generate reports which are stored in the cloud service 20 and accessible to law enforcement station computer systems 40) different types of law enforcement actions. In some embodiments, a collision exchange module may be included in application 25, for documenting and processing information arising from a traffic collision. In such a module, a law enforcement officer may scan or otherwise input information (e.g., from driver's licenses, vehicle registrations, etc.) related to multiple individuals involved in a collision (e.g., drivers, passengers, witnesses, etc.), as well as relevant insurance information (e.g., insurance information for all involved drivers/vehicles) to be included in a single collision exchange report within the module (i.e., the collision exchange module may include a pre-configured template for receiving information related to multiple parties involved in a traffic collision). The generated collision exchange report may be signed, locked and uploaded to the cloud service 20, and may further be distributed to all parties affected by such a collision, e.g., by utilizing printer 31 to print and distribute copies of the collision exchange report. The collision exchange module may include any further features and/or functionalities as may be described herein, for example, to allow the officer to include drawings of the scene, comments, audio, video and the like within the collision exchange report.

The information for each individual is associated with that individual within the application 25, such that other modules may be initiated and auto-populated with the associated information. For example, after completing and submitting a collision report, the officer may further pull up a citation module for issuing a citation to one of the involved individuals. The citation module may then be auto-filled with information about that individual, which was input into the collision report module, thereby saving the officer from having to re-input such information about the individual in the citation module.

In some embodiments, a crash module may be included in the application 25, which enables officers and other front-line responding personnel the ability to investigate, report, scan licenses and registrations, take pictures, videos, voice-to-text, create geo-tags of location and conduct and record field interviews for single- and multi-vehicle accidents in a much quicker and more efficient manner, allowing a traffic accident to be documented, processed and cleared in approximately ⅕ the amount of time that is required when utilizing conventional technologies, procedures and/or systems.

In some embodiments, a command module may be included within the system 10, which allows command staff (e.g., commanders, managers or other such authorized personnel associated with a law enforcement agency) to view a location of assets, analyze real-time crime data, collisions, citations, incidents or other such law enforcement-related activity. The command module further allows commanders the ability to view historical statistical data and trends, to more efficiently hire, train and deploy assets, as well as to better respond to incidents. The command module may be provided, for example, as a tool within law enforcement station computer systems 40, accessible to law enforcement station computer systems 40 through the cloud service 20 and/or within the application 25 and operated by law enforcement station computer systems 40. Additionally or alternatively, the command module may be provided within the application 25, operated on any law enforcement computer device, but accessible only to authorized users through the use of, for example, login/password or other such restricted-access authorization tools.

Modules within the application 25 may be pre-configured and saved by users, including information in certain fields. For example, an officer may be tasked with monitoring a particular traffic location for speeding violations. The officer may thus pull up a speeding citation module, enter certain information which will remain the same for multiple expected citations (e.g., date, location, radar/lidar ID, weather/visibility conditions, etc.) into form and then save the form as a template within the application 25. The officer may then pull up the saved template and fill-in any remaining fields with relevant driver information each time a driver is stopped and cited for speeding.

The application 25 may include reference information which may be associated with particular types of reports (e.g., information to accompany citations or warnings for certain types of violations, to accompany field interview with crime victim, etc.). For example, some states may suggest or require that law enforcement officers provide a “Victim's Bill of Rights” or other such reference information or notice to a crime victim. This reference information may be included within the relevant module (e.g., victim statement/interview report) and may be accessed by the law enforcement officer using the computer device 30, printed by the printer 31 and delivered to the individual.

Modules for generating reports related to various types of law enforcement activities may be included within the application 25, including DUI citations, crash or collision reports, incident reports, warnings, insurance exchange information, as well as other such reports for law enforcement-related activities.

In some embodiments, the system 10 may include a squad car camera 33, which may be mounted in a law enforcement vehicle. The squad car camera 33 may capture high definition video of a scene, from its location in the squad car, and transmits the video to a law enforcement officer computer device 30 (which may be a mobile, handheld device, or alternatively may be a computer device located onboard the squad car) and to the application 25. Further, a recording device 35, which may be an officer-worn recording device, captures audio information from the scene and transmits the audio information to the computer device 30 and application 25. The video and audio information may be automatically tagged to reports created by the modules in the application 25 based on time, geo-location, incident type and the like.

The system 10 may further include a body-worn camera 37, which may be worn by a law enforcement officer to capture video of a scene from the officer's point-of-view. The body-worn camera 37 transmits video information (and may further include an audio device for capturing and transmitting audio information) to a law enforcement officer computer device 30 and application 25, which may be automatically tagged to reports created by the modules in the application 25 based on time, geo-location, incident type and the like.

The system 10 is fully compliant with requirements provided by the Federal Information Processing Standards (FIPS) as well as the FBI Criminal Justice Information Services (CJIS), particularly as related to security of communications and information in the law enforcement cloud service 20. All data connections within the system 10 are secured with FIPS-compliant encryption and all devices (e.g., law enforcement officer computer devices 30 and law enforcement station computer systems 40) are authenticated with X.509 certificates. All authentications within the system 10 may be dual-factor authentication.

The system 10 is a module-based mobile report generation and processing system. The law enforcement officer computer devices 30 may be protected by a ruggedized case, complying with military specifications, and may be an Apple iPad or iPad mini operating on an Apple iOS platform. Officers utilize the system 10 to conduct investigations, document evidence, create tickets and warnings, write reports and make such reports available through the web interface (e.g., through communication with the cloud service 20) in real-time. These reports can may then be reviewed (e.g., by law enforcement personnel operating law enforcement station computer systems 40) for quality control, provide instant command updates and quickly integrate into current criminal justice data base systems or Records Management Systems (RMS).

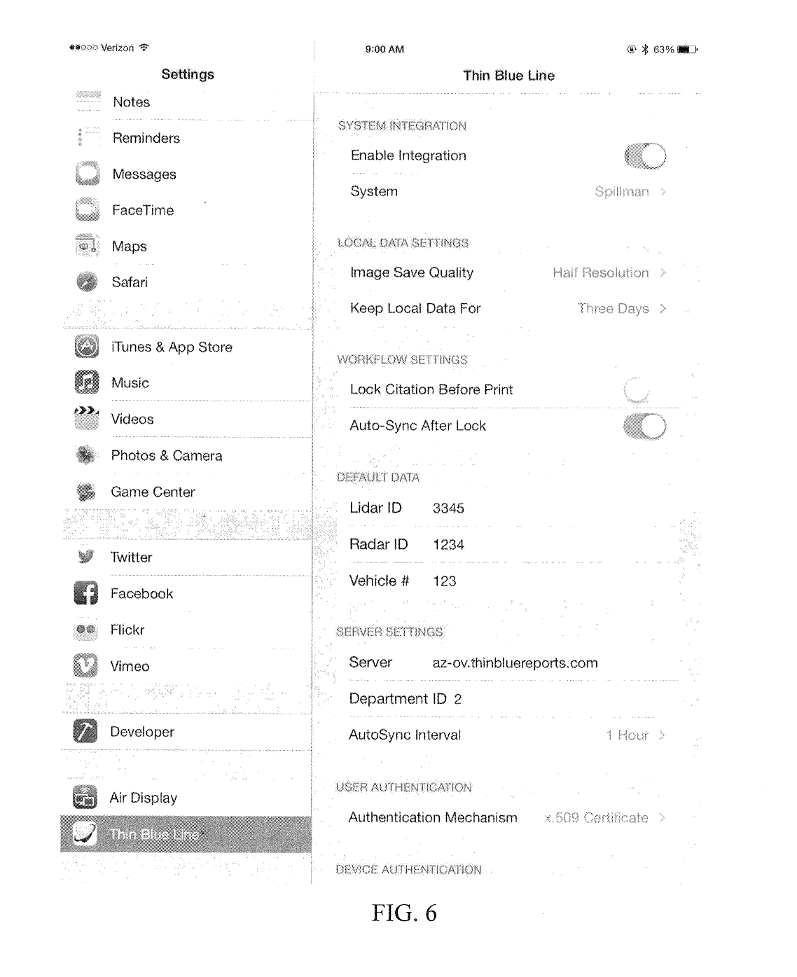

The system 10 may further include mobile device management capabilities, which may be provided through, or in communication with, the law enforcement cloud service 20. For example, managers or other authorized users within a law enforcement agency may access a mobile device management tool by logging into the law enforcement cloud service 20 (e.g., through a web-based portal using law enforcement station computer systems 40). The mobile device management tool allows such authorized users to configure or alter settings and/or accessibilities available to users of law enforcement officer computer devices 30. Some of the customizable settings for computer devices 30 using the system 10 are shown in FIG. 6. A law enforcement officer using a computer device 30 may have sufficient authorization to alter some of these settings, while others may be access-restricted such that they may only be changed by an authorized user through the mobile device management tool.

The system 10 includes multiple modules for various law enforcement-related purposes within the application 25. Each such module is seamlessly bundled into a single unit (e.g., the application 25 running on computer devices 30), making law enforcement officers more effective and their data collection and other law enforcement activities more efficient.

It should be emphasized that the above-described embodiments of the present disclosure, particularly, any “preferred” embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A computerized system for documenting and processing law enforcement actions, comprising:
at least one law enforcement officer computer device operating a law enforcement action documenting and processing application, said law enforcement action documenting and processing application providing an interface for generating reports, said interface for generating reports including a plurality of preconfigured report templates, whereby a report is generated by providing relevant information into fields within a selected report template;
a law enforcement station computer system;
a law enforcement cloud service for storing reports, hosted at least partially on a server and electronically accessible over at least one network system to the at least one law enforcement officer computer device and the law enforcement station computer system; and
at least one third party data systems, storing information relevant to law enforcement activities, said at least one third party data systems including at least one of a law enforcement Records Management System and a judicial system database,
wherein the law enforcement cloud service is configured to:
facilitate a search of the at least one third party data systems based on information received from the at least one law enforcement officer computer device;
provide to the at least one law enforcement officer computer device, as a result of the search, information corresponding with the information received from the at least one law enforcement officer computer device, said law enforcement action documenting and processing application being operable to populate a field in the selected report template with the information resulting from the search;
store reports received from the at least one law enforcement officer computer device; and
provide the law enforcement station computer systems with access to the stored reports.

2. The system of claim 1, wherein the at least one law enforcement officer computer device includes a camera for capturing images or video, and the law enforcement action documenting and processing application is configured to receive the image or video data and provide the image or video data into fields within the selected report template.

3. The system of claim 1, wherein the at least one law enforcement officer computer device includes an audio recording device for capturing audio information, and the law enforcement action documenting and processing application is configured to receive the audio information and provide the audio information into fields within the selected report template.

4. The system of claim 1, further comprising a squad car video camera configured to capture video information and transmit the captured video information to the law enforcement action documenting and processing application.

5. The system of claim 1, further comprising a body-worn camera configured to be worn by a law enforcement officer and transmit the video information to the law enforcement action documenting and processing application.

6. The system of claim 1, wherein the law enforcement action documenting and processing application is configured to geo-tag at least one of: video information received from the at least one law enforcement officer computer device, audio information received from the at least one law enforcement officer computer device, video information from a squad car camera, video information received from a body-worn video camera and audio information received from a body-worn audio device.

7. The system of claim 1, further comprising a printer for printing generated reports.

8. The system of claim 1, wherein the law enforcement action documenting and processing application includes at least one of a warning module for generating a warning for violations of law, and a citation module for generating a citation for violations of law.

9. The system of claim 1, wherein the law enforcement action documenting and processing application includes a collision exchange module configured to receive information related to a traffic collision and to generate a collision exchange report.

10. The system of claim 1, wherein the law enforcement action documenting and processing application includes a DUI module configured to document a driving-under-the-influence incident and to generate a citation.

11. A computerized method for documenting and processing law enforcement actions, comprising:
providing a law enforcement action documenting and processing application for operation by at least one law enforcement officer computer device, said law enforcement action documenting and processing application providing an interface for generating reports, said interface for generating reports including a plurality of preconfigured report templates, whereby a report is generated by providing relevant information into fields within a selected report template;
providing a law enforcement cloud service for storing reports, hosted at least partially on a server and electronically accessible over at least one network system to the at least one law enforcement officer, computer device and a law enforcement station computer system, the law enforcement cloud service being configured to:
facilitate a search of at least one third party data systems based on information received from the at least one law enforcement officer computer device, wherein the at least one third party data systems store information relevant to law enforcement activities, and include at least one of a law enforcement Records Management System and a judicial system database;
provide to the at least one law enforcement officer computer device, as a result of the search, information corresponding with the information received from the at least one law enforcement officer computer device, said law enforcement action documenting and processing application being operable to populate a field in the selected report template with the information resulting from the search;
store reports received from the at least one law enforcement officer computer device; and
provide the law enforcement station computer systems with access to the stored reports.

12. The method of claim 11, wherein the at least one law enforcement officer computer device includes a camera for capturing images or video, and the law enforcement action documenting and processing application is configured to receive the image or video data and provide the image or video data into fields within the selected report template.

13. The method of claim 11, wherein the at least one law enforcement officer computer device includes an audio recording device for capturing audio information, and the law enforcement action documenting and processing application is configured to receive the audio information and provide the audio information into fields within the selected report template.

14. The method of claim 11, wherein the law enforcement action documenting and processing application is configured to receive video information from a squad car video camera.

15. The method of claim 11, wherein the law enforcement action documenting and processing application is configured to receive information from a body-worn camera.

16. The method of claim 11, wherein the law enforcement action documenting and processing application is configured to geo-tag at least one of: video information received from the at least one law enforcement officer computer device, audio information received from the at least one law enforcement officer computer device, video information from a squad car camera, video information received from a body-worn video camera and audio information received from a body-worn audio device.

17. The method of claim 11, further comprising:
providing a printer for printing generated reports.

18. The method of claim 11, wherein the law enforcement action documenting and processing application includes at least one of a warning module for generating a warning for violations of law, and a citation module for generating a citation for violations of law.

19. The method of claim 11, wherein the law enforcement action documenting and processing application includes a collision exchange module configured to receive information related to a traffic collision and to generate a collision exchange report.

20. The method of claim 11, wherein the law enforcement action documenting and processing application includes a DUI module configured to document a driving-under-the-influence incident and to generate a citation.
